(19) United States
(12) Patent Application Publication
(10) Pub. No.: US 2010/0135651 A1
(43) Pub. Date: Jun. 3, 2010

(54) METHOD AND DEVICE FOR LOCATING A COMMUNICATION SOURCE AND MOBILE COMMUNICATION SYSTEM USING ONE SUCH DEVICE

(76) Inventor: Christophe Tiraby, Sceaux (FR)

Correspondence Address: YOUNG & THOMPSON, 209 Madison Street, Suite 500, Alexandria, VA, 22314, US

(21) Appl. No.: 12/598,977

(22) PCT Filed: May 5, 2008
(86) PCT No.: PCT/EP08/55488

§ 371 Date: Nov. 5, 2009

(30) Foreign Application Priority Data
May 10, 2007 (FR) 0754970

(51) Int. Cl. H04B 10/08

(52) U.S. Cl. 398/9

(57) ABSTRACT

Method for locating an optical radiation source of the kind in which receivers like infrared receivers are used in an on/off mode, characterized in that it consists in:
arranging at least one receiver of optical radiation at a point for which localization is sought, the receivers being arranged in order to discriminate separate zones or sectors in a space in which at least one determined transmitter of an optical radiation source is present;
driving the transmitting emission from the transmitter in order to provide a recurrence of pulses having determined emission powers;
locating the point associated with the receiver by detecting the state of the receiver or the receivers in response to the recurrence of pulses having determined emission powers.

The present invention relates to a method for locating a mobile communication source and to a device for locating a mobile communication source. The invention is suitable for a mobile communication system which uses at least one such device.

In the state of the art, an infrared source has always been used to communicate digital information between two devices communicating, for example in a mobile communication system. For example, it is known to use infrared rays to detect the position of a moving body which carries detection sensors of the infrared radiation. It is also known to use an infrared source of rays to exchange commands or the like between a first device and a second device or more devices.

The problem of locating a communication source is particularly acute in the case of a fleet of cooperative robots, like artificial fishes, and which exchange digital information using infrared communication channels. In such a communication system, the different robots produce and receive such information, but also one or more beacons are provided so as to form for example relays of information with a central inspecting device of the fleet of cooperative robots.

According to the invention, the locating device is used on at least a robot so as to enable it to determine the localization of at least a communication source with which it is in relation at one given moment.

In the state of the art, under an IrDa international standard, communication components as well as a communication protocol using the infrared waves have been designed. Thus transmitters are provided enabling them to carry out bidirectional transmissions with the following features:
Transmission is relatively directive, i.e. that it is made in the line of sight;
Transmitters present a low cost;
They have a good immunity with daylight;
They provide with an important data rate;
They have a low electrical consumption; and
Their receiving part has a given sensitivity and is provided with a mean producing a signal of detection of the Boolean type depending on the fact that the received power is greater or not than their sensitivity.

However, immediate source localization by means of such transmitters is not allowed with the source which they exchange data, because of their directivity, these transmitters always suppose that the source with which they operate is in the angular zone of good reception such as it is known and defined. Moreover, because of their higher sensitivity, they are more capable to be blinded by infrared sources the power of which would be too high and that would prevent a correct detection of the angular sector in which the transmitter would be.

The invention brings remedy to this state of the art. Indeed, it relates to a method for locating an optical radiation source of the kind in which, receivers like infrared receivers, are used in an on/off mode. The invention is characterized in that it consists in:
arranging at least one receiver of optical radiation at a point for which localization is sought, the receivers being arranged in order to discriminate separate zones in a space in which at least one determined transmitter of an optical radiation source is present;
driving the transmitting emission from said transmitter in order to provide a recurrence of pulses having determined emission powers;
locating the point associated with the receiver by detecting the state of the receiver, or of the receivers, in response to the said recurrence of pulses having determined emission powers.

According to another aspect of the invention, the transmitting emission from said transmitter is modulated according to a law of predetermined decreasing powers and in that the localization is determined on the basis of the state of receivers which react to the lowest received power.

The invention relates to also a device for locating a communication source, said device being of the type having a plurality of detectors of infrared waves in an on/off mode, each detector being inserted in a support absorbing the infrared waves and leaving the infrared rays coming from possible communication sources in a determined geometric sector. The invention is characterized in that it comprises a means, at the input of which are provided the shaped signals from the other detectors, for determining a channel of the receiver, or of the receivers, located in view of at least a communication source generating a recurrence of pulses, having given powers.

According to another aspect of the invention, the device presents a distribution of several receivers in zones separated by walls in order to locate the transmitting communication source in a geometric sector of the space, the determined variation of powers of the transmitting communication source providing a factor of contrast.

According to another aspect of the invention, the device comprises a means for carrying out a calibration associated with the decoding which cooperates with a means for estimating the distance/proximity between the transmitting communication source and a receiver.

According to another aspect of the invention, the device comprises a means for detecting an obstacle which cooperates with a means for providing an interrogation wave and with a means for locating the interrogation wave or its reflection by an obstacle.

According to another aspect of the invention, a transmitting communication source and a receiver are provided on a same mobile communicating robot with separation by a partition in order to permit the detection of the reflection of the emission and to estimate power of this reflection.

According to another aspect of the invention, the device comprises a detection circuit the input terminals of which are electrically connected to the different sensors, means for shaping the electrical signals received from of each sensor which are connected to a means for detecting a channel of the sensor placed in view of sight of at least a communication source, and in that identifiers of the detected channel are then transmitted at the output of the detection circuit to a circuit for memorizing the identifiers of the section of the space in which the communication source has been detected by the detected channel.

According to another aspect of the invention, the channel of the sensor located in the line of sight of a communication source is detected on the basis of the lowest detected power and on the basis of at least the one communication source producing a recurrence of pulses and/or frames of radiating powers according to a decreasing power having a given decay law.

According to another aspect of the invention, the said given decay law is of the exponential type, each pulse (pᵢ) and/or frame (ti) having a determined amplitude (ai) during a determined duration (DT), and is separated from the next frame (ti+1) with a given duration (DR).

According to another aspect of the invention, the communication source adapted to a locating device and comprises a micro controller which includes a means for running a program to generate a sequence of instructions capable to activate a first output port of the micro controller) to control the operation of an active switch, and a second group of output ports which are connected to a network of resistors, designed to produce an amplitude of pulses and/or frames according to a law of exponential decay and in that the common point of the network is connected to the anode of a diode transmitting an infrared wave, the cathode of which is connected to the electrode of drain of the switch whose electrode of source is connected to the electrical ground and the electrode of gate is connected to the output port of the micro controller, in that the resistors are connected each one to a determined output port of the group of output ports of the micro controller, and in that the resistor is connected to several output ports of the group of output ports to provide a quantity of additional current compared to the other resistors.

According to another aspect of the invention, the device cooperates with a communicating device and with bidirectional infrared means, the communicating device comprising a micro controller and an interfacing circuit which is connected by an outgoing way of the micro controller to a TX asynchronous series emitting port of the micro controller and by an incoming way of the micro controller to an RX asynchronous series receiving port, a common receiving line being mounted out of open collector, the receiving output of each receiver-transmitter module being transmitted to this line by a matching circuit of “open collector buffer-type”.

Finally, the invention relates to a communication system characterized in that it comprises a plurality of mobile communicating robots, at least one of which being equipped with a locating device according to the invention.

Other characteristics and advantages of the present invention will be better understood using description and of the drawings among which:

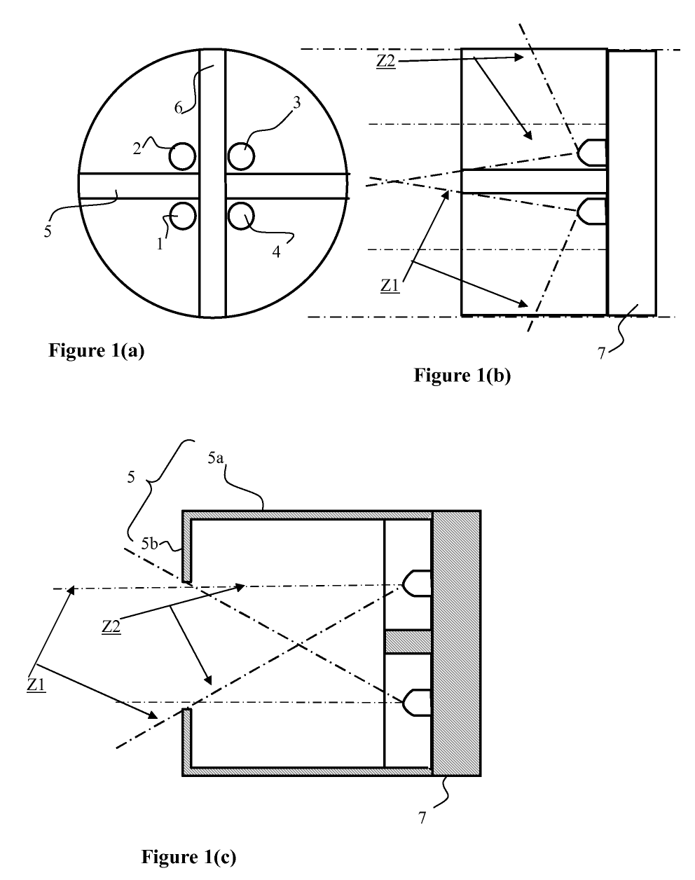

FIGS. 1 (a) to 1(c) represent diagrams of two specific embodiments of a device of the invention;

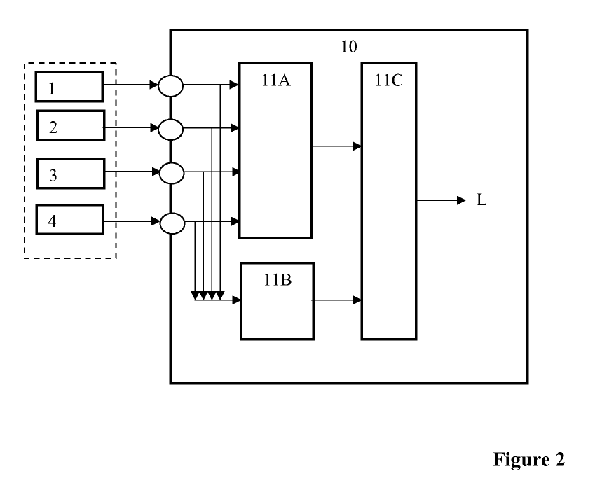

FIG. 2 represents a diagram of a portion of a circuit in a locating device of FIG. 1;

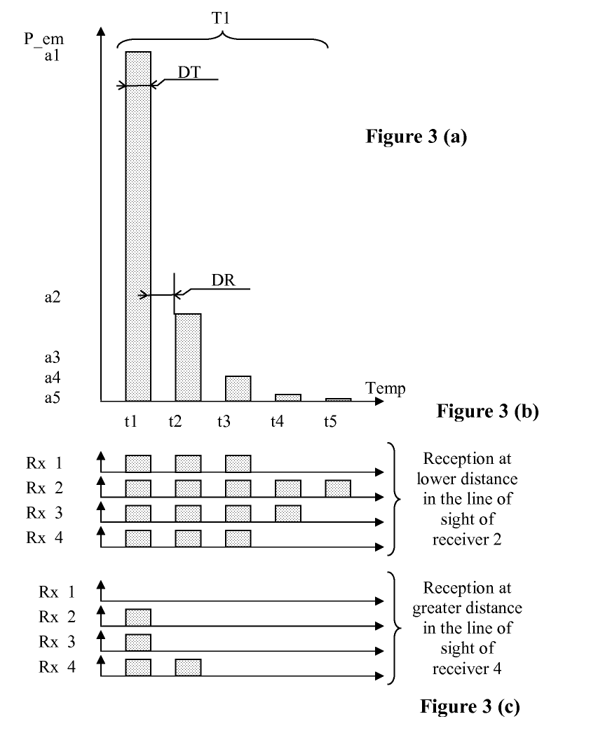

FIGS. 3(a) to 3(c) represent chronograms implemented in a communication source adapt to locating device according to the invention in two situations of reception;

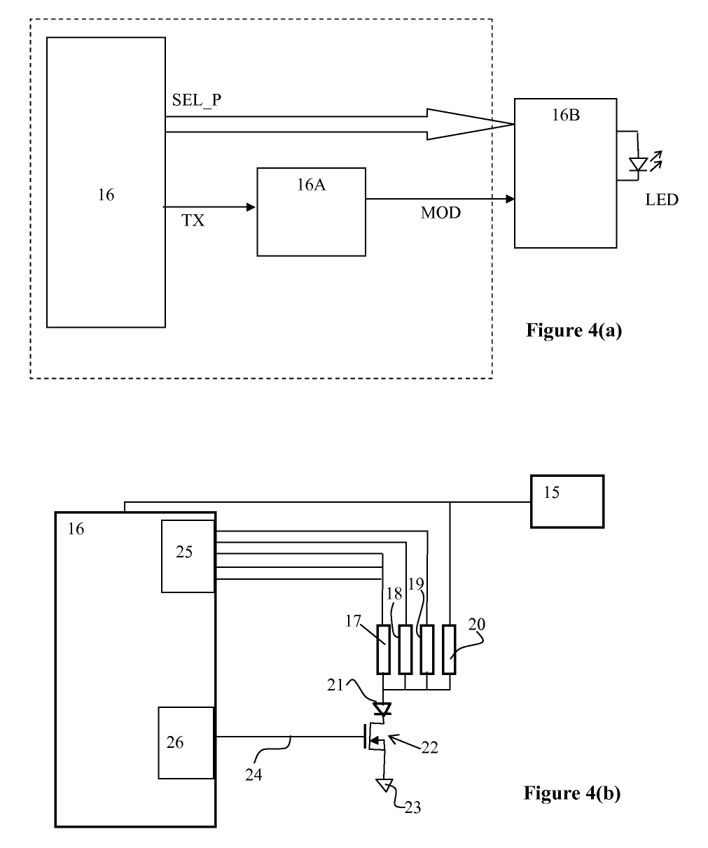

FIGS. 4(a) and 4(b) represent a diagram of a portion of an electronic circuit in the communication source implementing the chronogram of FIG. 3 (has);

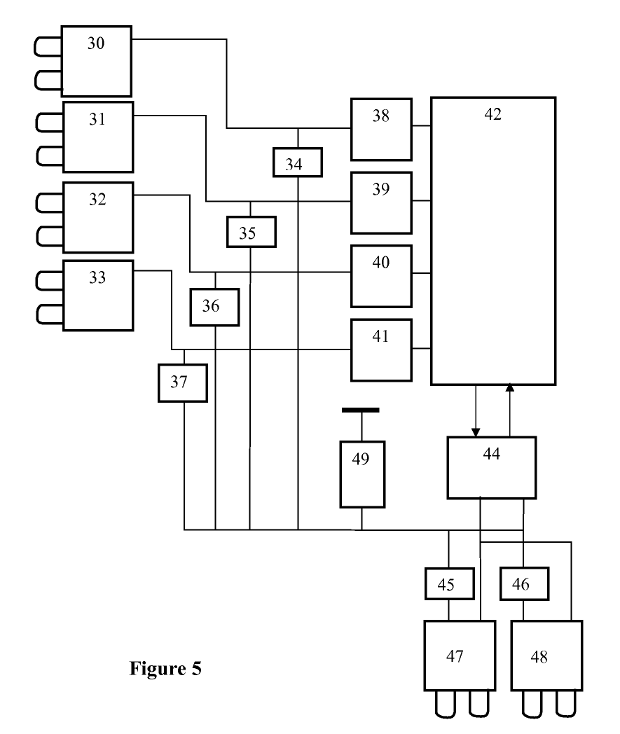

FIG. 5 represents a diagram of a portion of a electronic circuit in the locating device according to the invention;

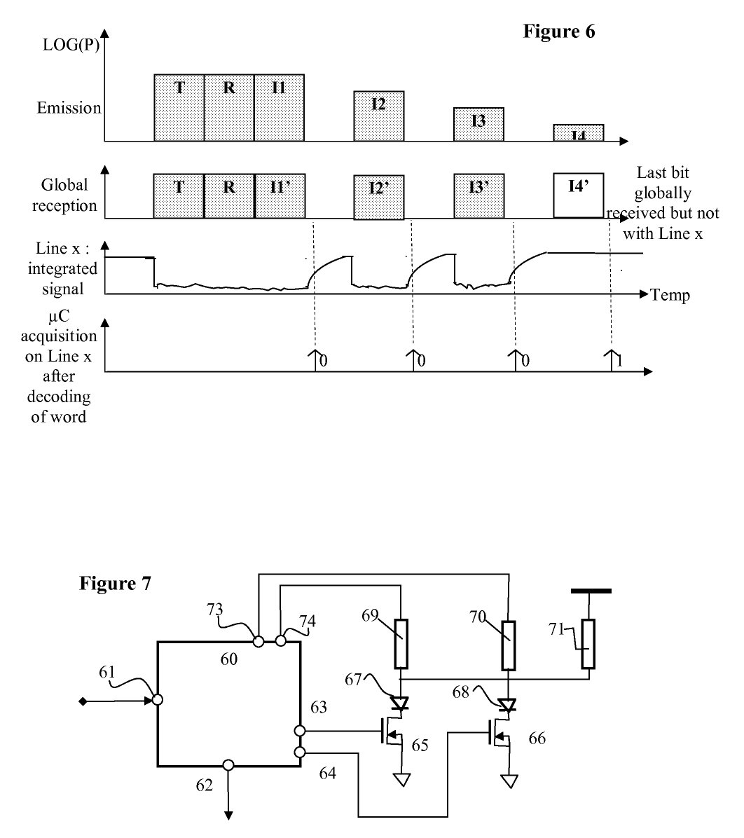

FIG. 6 represents a chronogram of the exchanged or processed signals by the communication source and a locating device of the invention;

FIG. 7 represents a diagram of a portion of a electronic circuit in a locating device of the invention;

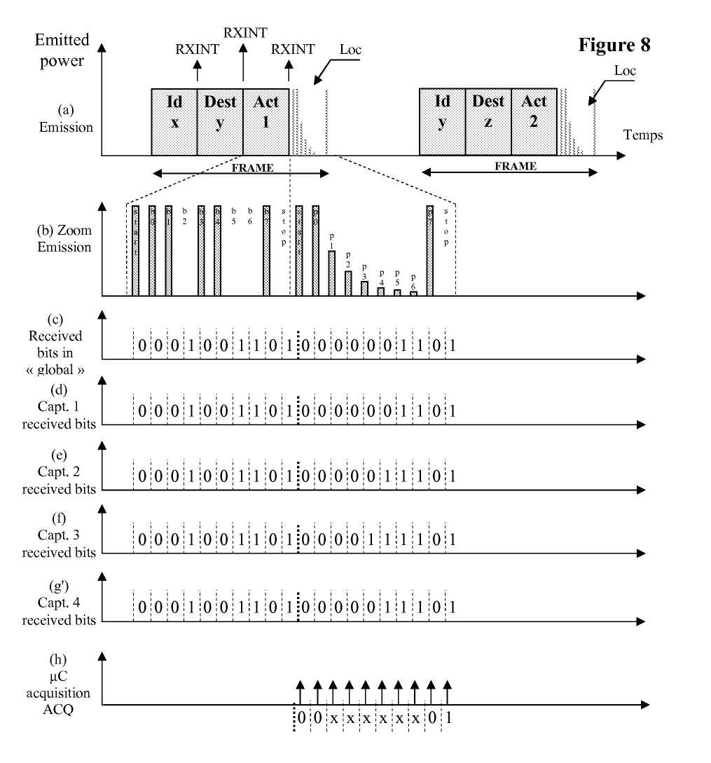

FIG. 8 represents chronograms implemented in another embodiment of the method of the invention; and.

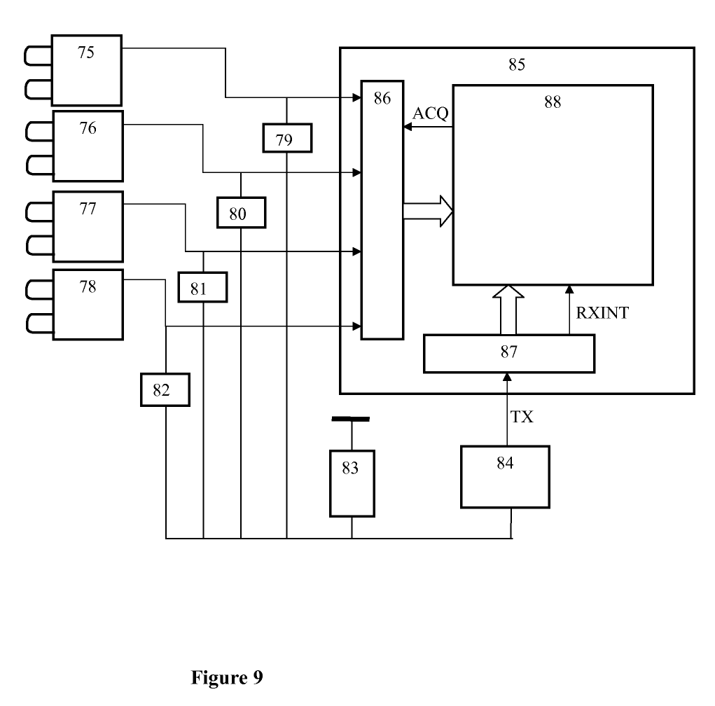

FIG. 9 represents a diagram of a portion of a electronic circuit in a locating device according to an embodiment of the method of the invention.

According to the invention, location permitted by the means of the invention makes it possible according to circumstances to determine:
the relative position of a locating device relatively with a direct or indirect communication sources;
the presence of an obstacle relatively to a locating and/or communicating device; and
the distance from the locating device to a direct or indirect communication source.

A source of direct communication comprises at least a communication device which comprises a means for generating at least a communication signal at a determined power, while a source of indirect communication profits from the reflections produced by the aforementioned determined power.

The location according to the invention will be now described in itself.

On the FIG. 1 (a), the diagram of an embodiment of a locating device according to the invention has been shown. In order to locate the position or the geographical sector in which a possible communication source is set, the locating device comprises several sensors of the optical wave used by the communication source. Preferably, as it has been explained above, an infrared wave is used which comes from an IrDa transmitter. Each sensor 1-4 is laid out on an absorbent support 7 of the optical wave used and on which are also laid out partitions like the partitions 5 and 6 so that each sensor 1-4 receives radiated power by a source being in a sector of the space substantially limited by the straight lines issued from the centre of the sensor and which are intercepted by the edges of partitions 5 or 6. As it is represented within the associated FIG. 1 (b), the normal angle of reception of sensor 1 is limited on the sector Z1 and that of sensor 2 is limited on the Z2 sector. It is thus for each sensor laid out on the locating device of the invention.

Particularly, according to the nature of the radiation resulting from the communication source, and according to the geometry of the sector of detection which one wants to associate to each sensor, the shape and material of support 7 and partitions 5 and 6 are designed in a particular manner. Especially, it is possible to add a symmetrical plate of support 7, shown at the right view (b) in order to mask the largest portion of the radiation which would not be in the shown plane in the top view at FIG. 1(a).

In order to carry out a 3D locating device, for example, it is possible to couple with the locating device of FIG. 1 an identical locating device whose support is joined or backed to the support 7 of the locating device represented on FIG. 1.

The number of sensors 1-4 is not limited and it is only determined by the number of sectors which one wishes to detect in the locating device of the invention.

On FIG. 1 (c), a cross-section of another embodiment of a locating device used in the invention has been shown with a chamber limiting the sectors of localization Z1, Z2, . . . . The chamber consists in a cylindrical wall 5 made up of a closed axial portion 5a to its left portion with the drawing by a pierced annular portion 5b of an opening allowing the passage of the wave of illumination by a determined transmitter. This provision can be combined with the provision of FIG. 1 (b) like it was represented without reference on FIG. 1 (c).

On FIG. 2, a portion of an electronic circuit mounted in the substrate 7 of the locating device of FIG. 1 has been shown. The electronic circuit in substrate 7 of the locating device of the invention comprises a detection circuit whose input terminals are electrically connected to different sensors 1-4 of the locating device. The detection circuit comprises shaping means of the received electrical signals of each sensor. To this end, the locating device according to the invention comprises a first mean 11A to determine at every time determined by an internal clock with the locating device 10, the electrical state of potential of each input channel connected to a detector, receiver or sensor associated with a localization sector Z1, Z2, . . . . The same signals are also combined in a combination circuit 11B so that as soon as an optical detector of radiation receives power greater than its threshold of sensitivity, an active signal is set.

A locating circuit 11C produces itself a signal of localization L by comparing the status of the state signals of each detector carried out by the circuit 11A when an active signal produced by the common or global detection circuit 11B is present. The final locating circuit 11C produces an active signal in relation to the channel (s) associated with each receiver in the line of sight with the communication source.

According to the method of the invention, it is proposed to modify the sources of communication used in a system of communication using a device for locating communication sources according to the present invention. Such a communication source must then emit a plurality of signals according to given powers using with the at least one communication device of, and, in the case of the location itself, according to determined directions or zones.

With the FIG. 3a, it has been drawn a chronogram of a recurrence T1 of N frames t1, t2, . . . of power produced by the communication source which is modified in the purpose of improving the localization of communication sources using the locating device of the invention. Each recurrence is made up of a sequence of N frames whose energy or power is decreasing according to a law of determined decay. In a particular mode of realization, the sequence comprises five frames and the law of decay is of exponential type. Each frame ti shows an amplitude ai within one duration DT, and is separated from the following frame ti+1 by a duration DR. According to systems of communication in which the invention is embodied, it is possible to set the number NR of frames, the law of decay, duration DT of each frame and the inactive duration Dr. The sequence is repeated with each recurrence T2, T3 . . . when one seeks to locate at least one communication source.

Each frame carries at least one communication word either to transmit information or to produce a power according to the aforesaid protocol. In an embodiment, the communication source integrates a series communication circuit under the coding of a bit of starting, follow-up of 8 bits the given ones and finished by a bit of stop. The binary word is thus attached with 10 bits.

Dead time DR is in particular envisaged so as to allow that the locating device can acknowledge the processed signal (in the means 11A and 11B (FIG. 2)).

On the FIG. 3 (b), an example of reception of an emission at short distance in front of the receiver or detector of the locating device has been shown. The status signals produced by the mean 11A are respectively Rx_1 to Rx_4. The circuit 11C determines at least a channel in the line of sight with the source by detecting the status of the Rx_i channel associated with the detector which reacts to the lowest emitted power by the source, that is to say the Rx_{—}2 channel here.

At FIG. 3 (c), an example of reception of an emission at long distance in front of the receiver or detector of the locating device has been shown. The status signals produced by the mean 11A are respectively Rx_1 to Rx_4. The circuit 11C determines the channel (or the channels) in the line of sight with the source and which thus reacts to the lowest emitted power, that is to say the Rx_{—}4 channel here.

At FIG. 4(a), a portion of an electronic circuit has been shown, which is integrated with a communication source intended to emit a light signal towards a locating device according to the invention. A control circuit 16 associated with the locating device comprises preferably a microcontroller whose a first output device produces a signal for selecting power of emission SEL_P and a second TX output device which is connected to a interface circuit 16A. In an embodiment, the interface circuit 16A is of IrDa type, the transmitters of optical radiation being IrDa infrared transducers.

The interface circuit 16A produces a modulation signal for a modulating circuit 16B which receives the selection signal of a given power SEL_P and the modulating signal MOD. At least one infrared emitting LED diode is connected to the output port of the emission modulating circuit 16B so that the said LED diode can radiate a sequence of frames at powers according to the described method using FIG. 3(a). In an embodiment, the emitting power of the communication source is generated by several diodes activated according to the power of each frame decided according to the method of the invention.

At the FIG. 4 (b) is represented an embodiment of an electronic circuit which comprises a micro controller 16 which receives an electrical supply voltage of an electrically controlled driving circuit 15. The micro controller 16 comprises a means for running a program to generate a sequence of instructions capable to activate a first output port 26 of the micro controller 16 to control the operation of an active switch as a MOS transistor 22, via a IRDA adaptation circuit (already explained at FIG. 4(a)), and a second group of output ports 25 which are connected to a network of resistors 17-20.

The network of resistors 17-20 is designed so as to produce frame amplitudes according to a law of exponential decay. If another law were desired, the network of resistors can be consequently adapted. The common node of network 17-20 is connected to the anode of a infrared emitting diode 21 whose cathode is connected to the electrode of drain of the MOS transistor 22 whose electrode of source is connected to the electrical ground 23 and the electrode of gate 24 is connected to the output port 26 of the micro controller 16 via the IRDA interface circuit 16A.

Resistors 18-20 are connected each one to a selected output port of the group of output ports 25 of the micro controller 16 while resistor 17 is connected to several output ports from the determined group of output ports 25 so as to profit from a capacity of additional current compared to the other resistors.

The program running at the micro controller provides the sequence of each recurrence T1, T2 represented on FIG. 3 by switching ON/OFF the transistor 22 by the output port 26 and while placing each determined port of the group of output ports 25 in a suitable state.

At FIG. 5, a device is shown pertaining to the communication system, the communication device comprising a location device 30-33 and means ensuring a bidirectional infrared communication 47, 48. Preferentially, the whole of the receivers and of the transmitters is of the components of the IrDa type. The communication device represented on FIG. 5 is built around a micro controller 42 and of a IrdA interfacing circuit 44 which is connected by an outgoing way of the micro controller 44 to a TX asynchronous series emission port of the micro controller and by an incoming way of the micro controller 44 to an RX asynchronous series reception port. This common IrdA reception line is driven as an open collector. The reception output port at each receiver-transmitter module of the IrdA type is connected to this line by an adaptation circuit 34-37 and 45, 46 of the open collector “buffer” type. Thus, the combination means of the receiving channels of the locating device comprises a negative logic OR of the whole of the received signals by the receivers.

Moreover, the output of each of the sensors and of the IrDa receivers with the locating device of the communication sources 30-33 is connected via an integrator 38-41 whose the integrated output is connected to a suitable input port of the micro controller 42. Each integrator comprises an adaptation circuit of the “open collector type” buffer of which the output port is connected to the common node of a load resistor at a direct driving potential of the device and of an integrating condenser whose other terminal is placed at the electrical ground. The common node is used as an integration output port to the integrator.

Owing to the fact that the reception line of the communication device at FIG. 5 is settled as an open collector, a pulling resistor 49 is connected between a direct current source and the reception line itself.

Therefore, the communication device at FIG. 5 comprises a locating device and a communication source which make it possible to implement the invention in the field of an application in which the communication device can be associated with a robot pertaining to a fleet of communicating robots, like artificial fishes driven by suitable actuators.

In an embodiment, means according to the invention are laid out in each communication device associated with a mobile communicating robot. Several mobile communicating robots are then associated in a fleet of mobile communicating robots, together supplemented by a central control station and if necessary by fixed or mobile beacons which are equipped with the same localization and communication means that the mobile communicating robots. It is possible to ensure at the same time:
a bidirectional communication between the different mobile communicating robots and if necessary some fixed stations, making it possible on the one hand to relay communications or on the other hand to relay orders making it possible to obtain an overall behaviour of the fleet of the mobile communicating robots; and
a location of each mobile communicating robot which passes near the mobile communicating robot equipped of either the aforesaid location device or a beacon or fixed station equipped of the aforesaid location device.

At FIG. 6, it has been drawn from the top to the bottom, respectively:

(a) a chronogram of emission produced by the communication source of a mobile communicating robot equipped with the communication device at FIG. 4;

(b) a chronogram of receiving with the bidirectional communication device of a mobile robot which passes in the line of sight of the communicating device of a mobile communicating robot producing the chronogram of emission indicated with the chronogram (a);

(c) a chart representing the integration of the signal of reception at the output of the one X of the integrators of the circuit at FIG. 5 mounted on the robot which receives a wave from the communication source as the mobile communicating robot working according to the chronogram of emission (a); and

(d) a chronogram of the acquisition made by the micro controller 42 of the circuit of FIG. 5 in the mobile communicating robot which passes in the vicinity and in the line of sight with the source of responsible communication of the chronogram of emission (a).

In the chronogram (a) of emission, first portion of a sequence of three frames of stronger amplitude is produced by a means to pass first information towards the receiving robots in which at least one of following information is:
a digital identifier of the communication source producing the chronogram (a) of emission;
a digital identifier of the device of reception which is recipient of the sequence of emission;
the indication of a type of message; and
a flag making it possible to indicate to the receiving device if the sequence which follows, depends on a law of decay like it was exposed according to the invention. The communication source comprises thus of a means of making it possible to determine if the sequence is a sequence of location or if it is a traditional sequence at a given constant power.

Particularly a sequence of location is envisaged with the frame T represented in the chronogram (a) for associated devices of communication:
with a mobile predecessor communicating robot,
with an obstacle supporting a communication source intended to produce an indicator of obstacle for the mobile communicating robots of the fleet of mobile communicating robots; or
with a stationary device being used as a base station of communication, or as a reloading station of the mobile communicating robots of the aforesaid fleet.

The emitted frame R contains an indicator, here the letter “R”.

Then, the sequence of locating frames is generated in the continuation of frames 11, 12, 13, 14 having decreasing amplitudes a1, a2, a3, a4 as previously described.

In the same time, and with a reduced amplitude due to the absorption of the wave produced by the communication source under the chronogram (a), the same frames successively T′, for the emitted frame T, R′ for the emitted frame R, I1′ for the emitted frame I1, I2′ for the emitted frame I2, I3′ for the emitted frame I3 are received respectively by the locating device 30-33 and by the system of bidirectional communication 47,48 of the one of the mobile communicating robots.

When the micro controller 42 decodes the frame T′ and when it recognizes it is the recipient of the communication source having produced the chronogram (a), it carries out the acquisition of the input ports connected to integrators 38-41 in order to know the state on the line of reception associated with detector X represented on the chart (c), an high level in voltage, as long as no signal is received, then an immediate low voltage in the event of reception, this voltage returning to the high level according to constant of the time determined one by the condenser and the resistor of the associated integrator.

The decoding means for the location, implemented by the micro controller 42 of the mobile recipient communicating robot, then make it possible to produce the state of reception of the corresponding line represented on the chronogram (D), that is to say the state “0” for the first three words and “1” for the last one, then indicating the absence of reception of this last frame for the line of reception considered.

According to the identification of detector 30-33 which is activated by the frames I1′, I2′, I3′ or I4′, it is then possible to carry out the localization of the communication source which produced the chronogram (A), i.e. the designation of the geographical sector, like the Z1 sector or Z2 sector at FIG. 1, in which the communication source is which has produced the chronogram (a).

In an embodiment, the communication device represented at FIG. 5 comprises also a means for measuring a distance between the communication device, especially when it is carried by a mobile communicating robot, and a communication system of emissions at variable powers as described in the invention. The mobile communicating robot comprises a locating device which comprises a means for carrying out a calibration associated with decoding making it possible to estimate the distance/proximity between transmitter and receiver. For this purpose, the transmitting communication system produces one infrared wave according to a determined sequence like the sequence of the chronogram (a), so that the receiving communication system can determine the received minimum power by the sensor concerned with the measuring. For this purpose, the micro controller 42 is equipped with a means for identifying a code of the transmitting communication system and with a table in which are recorded different values of distance associated with the amplitude with the last received frame. Particularly, when the locating device works on the means for measuring a distance between a transmitter and a receiver, the locating device activates only one line or channel comprising a receiver 30, a set-up common line buffer 34 and one integrator 38 to the input of microcontroller 42. The distance between the receiver and the transmitter or its reflection on an obstacle is indicated by the level of the frame of lower received power on the receiver. According to another point of view, the locating device of the invention comprises a mean for processing a table in which are recorded the different values of distance associated with the amplitude with the last received frame with each known obstacle in the environment of evolution. This last received frame corresponds to the smallest received power by a sensor or receiver whose identification of the channel to which it belongs allows at the same time an identification of the zone in which one finds a communication source or an obstacle and an estimate of the distance to which the communication source or obstacle is.

Particularly, the distance measuring means comprises also a means for carrying out a calibration with certain predetermined steps of the operation of the mobile communicating robot equipped with such a distance measuring means, and particularly according to the whole of the possible transmitters recorded in a table of the possible obstacles with characteristics of calibration associated with each possible transmitter of the environment of evolution of the fleet of mobile communicating robots equipped with the such means of calibration. According to the context and the environment, the locating device as well produces an estimate of the distance on a determined obstacle in the environment of the robot which carries it as on another neighbouring robot.

According to another aspect of the invention, the locating device, the communication system or the communication device can, separately or in combination, be assembled in one or more modules which can then be used separately in the field of different applications.

According to another aspect of the invention, the wave produced by the communication source is an infrared wave, and the medium in which is transmitted the wave is a liquid medium like a swimming pool, a river, a lake or any aqueous area. The invention applies also when the medium of evolution of the mobile communicating robots is air or a transparent mixed medium mixing liquid and gas or comprising transparent separators with the optical wave used like the infrared one, such separators being made up for example by transparent partitions.

In an embodiment, such a locating device, with such a communication source and such a locating device was tested with a rate of transmission of 9600 bauds, and spaced recurrences of some tenth of second. In another test, one worked with a flow of 115.200 bauds with frames corresponding with a word of ten bits, duration of 870 microseconds sequence of two words followed by four power levels and an emission repeated with a recurrence of 25 Hz.

In another embodiment, it has been noted that, to reduce the probabilities of collision between recurrences if several mobile communicating robots worked, it was necessary to implement a means for allotting a different spacing between the various recurrences produced by the communication sources on each mobile communicating robot of the fleet of mobile communicating robots. Among the methods to make safe evolutions of several robots, it is used:
programming of the robots so that they present all-different timings of the recurrences, for example {38, 39, 40, 41, . . . } expressed in milliseconds what reduced the number of possible collisions and draw aside them temporally;
spacing the recurrences with a pseudo random duration;
leaving one identical duration between the recurrences for all the robots but supplementing with an algorithm of detection of superimposed frames and shifting the cycle in the event of detection of collisions.

In another embodiment, to make a means for detecting obstacle with IrDa transducers comprising a transmitter and an infrared receiver working alternatively, the invention proposes thus that it is represented on FIG. 7 a change of the diagram of FIG. 5, in which an additional micro controller 60 is interposed on the Tx asynchronous series transmission line between the output of the micro controller 42 of FIG. 5 and the corresponding input of the IrdA interfacing circuit 44.

Generally, the locating device of the present invention comprises a positioning of the infrared waves transmitter-and-receiver on the same mobile communicating robot with separation by a partition in order to allow to detect the reflection of the emission and to estimate the power of this reflection.

The micro controller 60 comprises an input port 61 and a first output port 62. When the Tx asynchronous series output port of the micro controller 42 (FIG. 5) is activated, the micro controller 60 comprises a means for determining the operating mode of the implemented communication device.

If the operating mode is decoded as being a type of normal operation, the contents of the input port 61 is copied on the first output port 62 which is connected to the input of the IrdA interfacing circuit 44 (FIG. 5). In this case, the communicating device, equipped with the means for detecting obstacles of FIG. 7, functions like the communicating device represented on FIG. 5.

If the operating mode is decoded as being a type of operation in detection of obstacles, on the basis of by-program predetermined sequencings, the micro controller 60 activates then output ports, respectively 63 and 64, connected to the gate electrodes respectively of a first MOS transistor 65 and of a second MOS transistor 66, and output ports 73,74 connected through a first resistor 69 and a second resistor 70 to the switches 65 and 66 not being ordered at the same time.

The other terminal of resistors 69 and 70 is connected on the one hand to a pulling resistor 71 connected to the positive potential of the direct current source of the communication device, and on the other hand with the anode of a first infrared transmitting diode 67 directed according to a first direction, or with the anode of a second infrared transmitting diode 68 directed according to one second direction. It is possible to increase the number of directions of interrogations of presence of obstacles. Preferably, the anodes of the infrared transmitting diodes are connected to the common point of supply power, which is fed in decreasing power by the way of power modulation according to the method of the invention.

When the operating mode is a mode of obstacle detection, the output port 62 is deactivated and the output port 63 is connected to the first diode 67 so that a sequence of interrogation frames of the obstacles in the first direction is produced.

In another embodiment, microcontroller 42 implements a means for decoding receiving frames which comprises a mean for identifying the communication source, for detecting the recipient identifier and in response to the recognition of the identifier in reception, a means for activating the location signal detection input port.

Receiving diodes of the location system 30-33 (FIG. 5) are then analyzed and the outputs of the integrators transmitted to 41 are scanned by the means for detecting obstacles integrated with the micro controller 42. In each detected recurrence, if the transmitting identifier of the communication source which consists in the first direction interrogating diode 65, is found, and according to the method of locating communication sources which is described especially with FIGS. 1 to 4, it is then possible to detect the presence of an obstacle in the aforementioned first direction.

When the mode of operation, detected by the micro controller 60, activates the output port 64, the same interrogation sequence is generated by diode 66 in the second direction and the same analysis that aforesaid is then carried out by the micro controller 42. In an embodiment, diode 66 is directed towards the rear one of the mobile communicating robot when first diode 65 is directed towards the front. For the concerned robot, it is thus possible to be located by at least a mobile communicating robot which follows the concerned mobile communicating robot. By increasing the number of robots, displacements having a substantially single direction of displacement for several mobile communicating robots arranged in one or more lines behind a driving mobile communicating robot, can be locally controlled.

In FIG. 8, chronograms of another embodiment of the method of the invention are drawn. In this other embodiment, the recurrence of frames of determined powers is transformed by comparison to the embodiment of the FIGS. 3a to 3c into a recurrence of pulses of given powers. Preferably, the pulses of given powers are gathered in location words inserted in multiword frames of communication of a conventional protocol of communication in the following way.

At least a frame of the recurrence comprises a word made up of a succession of pulses of given powers per emission of a transmitting device of optical waves like infrared waves. Preferably, the law of decay of the powers of each pulse is exponential like it was explained higher. One takes again the same principle of generation of the interrogation or localization wave that in the described mode using the FIGS. 3a with 3c. Then one takes again the same principle of detection by logical combination of the channels detected on a receiver with several sectors of detection, each sector of detection of the interrogation or location wave being associated to a receiving channel carried out on the receiver.

In this embodiment, the method of the invention consists, at the time of a step of emission of one interrogation or location wave, to generate at least a communication word in the communication protocol, including several pulses of exponentially decreasing powers. At the time of a step of location, the method consists in looking for the identifier of the receiving channel which receives the impulse of lower power.

At FIG. 8, the chronogram (a) represents two successive frames of communication, each one comprising of the first words of communication, Id, of identification of the transmitter, Dest, of identification of the recipient, Act, of action to be carried out by the recipient, and a last word of localization or location word, Loc. Each frame of communication is produced by a communication source which produces one optical wave like an infrared wave and which is intended to be received by a plurality of receivers capable to ensure the location of the aforesaid communication source. It is also possible that several of the receivers are coupled with transmitters, so that a frame which connects a robot of identifier Id=x with a robot of identifier Id=y, can be followed of a frame which connects the robot of identifier Id=y with a third robot of identifier Id=z. In such a case, at least the robot of identifier Id=y must comprise a device transmitting frames and a receiving device of frames. According to circumstances, a fleet of robots can be equipped with transmitting and receiving devices, while beacons are envisaged with simply transmitting devices and other beacons are envisaged with simply receiving devices.

One note finally that, in the embodiment of the method of FIG. 8, each receiving device must comprise a means for enabling it to synchronize itself, using a local clock, with the received frames in order to be able to precisely anticipate the establishment of the bits of the word of localization. To this end, the receivers which receive words of communication Id, Dest and Act are synchronized on the RXINT timing pulses generated by a processing device of the received words, which will be described further, this one reacting in a deterministic way after decoding of the bits of stop of each received word of communication.

With the chronogram (b), an enlarged view of the word Act and of the location word Loc at the first frame of communication of the chronogram (a). Only the time scale is increased. Each binary word, that it is communication word or location word, is composed, in this embodiment and according to the communications protocol used, of ten binary positions successively:
a bit of starting “start”,
eight message bits, and
a bit of ending “stop”.

For the first Id, Dest and Act words of each frame, each bit with “0” corresponds to the full power of transmitter, and each bit with “1” corresponds to an absence of power of transmitter or a power of transmitter representative of a level “0”.

For the location word Loc, the bit of starting “start” is with full power because it corresponds to one “0” and the bit of ending “stop” corresponds to an absence of power of transmitter because it corresponds to one “1”. In the embodiment, bits po and p7 are with full power in order to be always detected like “0” and thus facilitating the synchronization of the receivers. By exception to the communication protocol, the bits p1 with p6 enclosed between them are of decreasing powers according to a given law like an exponential law.

As it was defined in the embodiment especially described with the FIGS. 3a to 3c, a location device to implement the method of the invention comprises a plurality of receivers of the transmitted wave which are laid out on sectors so that the best directed receiver towards the transmitting source of the transmitted wave is sensitive with the pulse of lower power tha- the receivers of the sectors do not receive. Because of decay of the powers of the location word, it is thus possible of determining:
orientation of the transmission source and/or the receiving device with the identifier of the electronic detection channel connected to the receiver sensitive with the lowest power transmitted pulse; and
distance by the pulse order number of the strongest power pulse that the determined receiver receives.

With the chronograms (d) to (g) of FIG. 8, the state of detection of each electronic detection channel associated with the one of the four mounted infrared receivers on the four detection sectors of the device is shown. Each infrared receiver is arranged in a planar sector of 90 [deg.] in an example of realization.

The electronic detection channel connected to each infrared receiver is also connected to a negative logic OR operator output of which combines the detection states of the four channels in a line of received bits into global, represented to the chronogram (c).

In the embodiment at FIG. 8, it is noticed with the chronogram (h) that, whatever the distance with a transmitter in a location word Loc, whatever the number of infrared receivers, the receiving system will decode at least the bit of start and the bit po of maximum power in the form of two ‘0’, and the last two bits of maximum power p7 and “stop” in the form of a pair ‘1’. The 6 other bits (or binary positions) are with states which depend on the orientation and the distance relative from the transmitter of the location word and the receiving system.

If the receivers are IrDa standard infrared receivers, it is known that the active part of each bit of each word of ten bits comprises only one fraction of the available duration to transmit one of the bits of the word of ten bits, according to the standard irDa, of 3/16 of the time of bit. It results from it that synchronization must be carried out on the basis of the RXINT receiving signals of the preceding communication words in the multiword frame before opening the detection of the location word.

In the same way, it is known that the receivers of the IRDA type do not produce an output detection signal of the type proportional with the power of the interrogation or location wave, but that only if the received power is greater than a threshold of determined power, the output detection signal is placed at a value “1” or with a value “0” if not.

At FIG. 9, a received word processing device is represented which is particularly adapted to the method in the embodiment described at FIG. 8. This communication device, just like the device described at FIG. 5 comprises infrared receivers 75-78, “open collector” adapter circuits 79-82, a pulling resistor 83, a IRDA interface circuit 84 and a microcontroller 85.

To carry out the synchronization of the received word processing device, in order to ensure the detection of the pulses in the location word, the device of the invention uses an asynchronous reception device 87 of the “Universal Asynchronous Receiver Transmitter” UART type integrated with the microcontroller. This device 87 generates a RXINT signal at the end of the reception of each word of the frame of the communication protocol that makes it possible to the processing module 88 of the microcontroller to control the acknowledgement of the input register 86 by ACQ order in a deterministic way. For that, a logic means, like a program of interruption started by RXINT signal, analyzes the last received word compared to the context in order to be located in the frame of the communication protocol, then calculates the time before the supposed occurrence of the “start” bit of the location word Loc. With the expiry of this time, the reading of register 86 is carried out, then repeated in sequences spaced of the time of interval between bits in order to make the complete acquisition of the state of receivers 75-78, for the “start”, po to p7 and “stop” bits.

Lastly, like it was described above, the described method by using the FIGS. 8 and 9 can be implemented in a large variety of location devices and mobile communication systems including:
electronic boards including at least an infrared receiver or the like, and at least a microcontroller to process the detection signals of at least a electronic detection channel associated with the receiver and to deduce from them the orientation and/or distance from a source providing at least a recurrence from location power frames like some frames reduced to a unique location word;
electronic boards including at least an infrared source or the like, activated by a microcontroller producing at least a recurrence of location power frames like some frames reduced to a unique location word;
electronic boards including a transmitting portion and a receiving portion adapted with the locating method of the invention;
fixed or mobile communication systems, including communicating robots, locating beacons, obstacle detecting systems, etc.

1. Method for locating an optical radiation source of the kind in which receivers like infrared receivers are used in an on/off mode, characterized in that it consists in:
arranging at least one receiver of optical radiation at a point for which localization is sought, the receivers being arranged in order to discriminate separate zones or sectors in a space in which at least one determined transmitter of an optical radiation source is present;
driving the transmitting emission from said transmitter in order to provide a recurrence of pulses having determined emission powers;
locating the point associated with the receiver by detecting the state of the receiver or the receivers in response to the said recurrence of pulses having determined emission powers.

2. Method according to claim 1, characterized in that the transmitting emission from said transmitter is modulated according to a law of predetermined decreasing powers, and in that the localization is determined on the basis of the state of receivers which react to the lowest received power.

3. Method according to claim 1, characterized in that said recurrence of pulses of determined powers is generated in the form of frames of determined powers.

4. Method according to claim 1, characterized in that said recurrence of pulses of determined powers is generated in the form of a binary location word (Loc) in a multiword frame (Id, Dest, Act) in a multiframe communication protocol.

5. Device for locating a communication source, said device being of the type having a plurality (1-4) of detectors of infrared waves in an on/off mode, each detector being inserted in a support absorbing the infrared waves and leaving the infrared rays coming from possible communication sources in a determined geometric sector or zone, characterized in that it comprises a means, at the input of which are provided the shaped signals from the other detectors, for determining a channel of receiver, or of the receivers, located in view of at least a communication source generating a recurrence of pulses, having given powers.

6. Device according to claim 5, characterized in that it presents a distribution of several receivers in zones separated by walls in order to locate a transmitting communication source in a geometric sector of the space, the determined variation of powers of the transmitting communication source providing a factor of contrast.

7. Device according to claim 5, characterized in that it comprises a means for carrying out a calibration associated with the decoding which cooperates with a means for estimating the distance/proximity between the transmitting communication source and a receiver.

8. Device according to claim 5, characterized in that it comprises a means for detecting an obstacle which cooperates with a means for providing an interrogation wave and with a means for locating the interrogation wave or its reflection by an obstacle.

9. Device according to claim 5, characterized in that a transmitting communication source and a receiver are provided on a same mobile communicating robot with separation by a partition in order to permit the detection of the reflection of the emission and to estimate the power of this reflection.

10. Device according to claim 5, characterized in that it comprises a detection circuit (10) the input terminals of which are electrically connected to the different sensors (1-4), means for shaping the electrical signals received from each sensor which are connected to a means for detecting a channel of the sensor placed in view of sight of at least a communication source, and in that identifiers of the detected channel are then transmitted at the output of the detection circuit (10) to a circuit (11) for memorizing the identifiers of the sector of the space in which the communication source has been detected by the detected channel.

11. Device according to claim 10, characterized in that the channel of the sensor located in the line of sight of a communication source is detected on the basis of the lowest detected power and on the basis of at least the one communication source producing a recurrence of pulses and/or frames of radiating powers according to a decreasing power having a given decay law.

12. Device according to clam 11, characterized in that the said given decay law is of the exponential type, each pulse (pᵢ) and/or frame (ti) having a determined amplitude (ai) during a determined duration (DT), and is separated from the next frame (ti+1) with a given duration (DR).

13. Device according to claim 12, characterized in that the communication source adapted to a locating device comprises a micro controller (16) which includes a means for running a program to generate a sequence of instructions capable to activate a first output port (26) of the micro controller (16) to control the operation of an active switch (22), and a second group of output ports (25) which are connected to a network of resistors (17-20), designed to produce an amplitude of pulses and/or frames according to a law of exponential decay and in that the common point of the network (17-20) is connected to the anode of a diode transmitting an infrared wave (21) the cathode of which is connected to the electrode of drain of the switch (22), the electrode of source of which is connected to the electrical ground (23) and the electrode of gate (24) is connected to the output port (26) of the micro controller (16), in that the resistors (18-20) are connected each one to a determined output port of the group of output ports (25) of the micro controller (16), and in that the resistor (17) is connected to several output ports of the group of output ports (25) to provide a quantity of additional current when compared to the other resistors.

14. Device according to claim 5, characterized in that it cooperates with a communicating device and with bidirectional infrared means (47, 48), the communicating device comprising a micro controller (42) and an interfacing circuit (44) which is connected by an outgoing way of the micro controller (42) to a TX asynchronous series emitting port of the micro controller and by an incoming way of the micro controller (42) to an RX asynchronous series receiving port, a common receiving line being mounted out of open collector, the receiving output of each receiver-transmitter module being transmitted to this line by a matching circuit (34-37 and 45, 46) of “open collector type” buffer.

15. Device according to claim 5, characterized in that the micro controller uses a RXINT receiving word signal on its UART module (87, FIG. 9), activated at the time of the reception of the first words in the frame of a communication protocol, to carry out a software interruption to estimate the time of occurrences of different bits of a location word Loc in order to do the acquisition in correspondence of the state of the receivers to each one of these times of occurrence.

16. Communication system characterized in that it comprises a plurality of mobile communicating robots, at least one of which is equipped with a locating device according to claim 5.

17. Method according to claim 2, characterized in that said recurrence of pulses of determined powers is generated in the form of frames of determined powers.

18. Method according to claim 2, characterized in that said recurrence of pulses of determined powers is generated in the form of a binary location word (Loc) in a multiword frame (Id, Dest, Act) in a multiframe communication protocol.

19. Device according to claim 6, characterized in that a transmitting communication source and a receiver are provided on a same mobile communicating robot with separation by a partition in order to permit the detection of the reflection of the emission and to estimate the power of this reflection.

20. Device according to claim 6, characterized in that it comprises a detection circuit (10) the input terminals of which are electrically connected to the different sensors (1-4), means for shaping the electrical signals received from each sensor which are connected to a means for detecting a channel of the sensor placed in view of sight of at least a communication source, and in that identifiers of the detected channel are then transmitted at the output of the detection circuit (10) to a circuit (11) for memorizing the identifiers of the sector of the space in which the communication source has been detected by the detected channel.
